(19) United States
(12) Patent Application Publication
(10) Pub. No.: US 2002/0057450 A1
(43) Pub. Date: May 16, 2002

(54) ELECTRIC SYSTEM FOR PROCESSING DOMESTIC INFORMATION

(76) Inventors: HARUHIKO MIO, KAWASAKI-SHI (JP); YASUO SATOH, KAWASAKI-SHI (JP); KOUJIROU ODA, KAWASAKI-SHI (JP)

Correspondence Address: STAAS & HALSEY LLP, 700 11TH STREET, NW, SUITE 500, WASHINGTON, DC, 20001, US

(21) Appl. No.: 09/295,108

(22) Filed: Apr. 21, 1999

Related U.S. Application Data
(62) Division of application No. 08/832,963, filed on Apr. 4, 1997.
Application No. 08/832,963 is a continuation of application No. 08/493,002, filed on Jun. 21, 1995, now abandoned.
Application No. 08/493,002 is a continuation of application No. 08/109,584, filed on Aug. 20, 1993, now abandoned.

(30) Foreign Application Priority Data
Nov. 11, 1992 (JP) 04-300714
Nov. 11, 1992 (JP) 04-300715

(51) Int. Cl. G06F 15/00

(52) U.S. Cl. 358/1.15

(57) ABSTRACT

An electric system for processing domestic information includes a data processing unit, an operation apparatus for sending operating information to the data processing system, a display for displaying displayed data generated by the data processing unit and a printing unit for printing printed data generated by the data processing unit, wherein the data processing unit and the operation apparatus employ a construction in which they are not connected by cables. The operation apparatus includes transmission means for transmitting the operating information to the data processing unit by the use of electromagnetic waves, while the data processing unit includes receiving means for receiving the operating information transmitted from the transmitting means.

The data processing unit includes transmitting means for transmitting displayed data to the display by the use of the electromagnetic waves, while the display includes receiving means for receiving the displayed data transmitted from the transmission means. Further, the data processing unit includes recording means for recording printed data on a recording medium.

Preferably, the printing unit comprises a printer, and this printer includes data reading means for reading recorded data of the recording medium which is mounted therein from outside and records the printed data, and printing control means for managing printing control processing of the printed data read by the data reading means.

### BACKGROUND OF THE INVENTION

1. Field of the Invention

The present invention relates to an electric system, for processing domestic information, comprising a data processing unit, an operation apparatus for giving operating information to the data processing unit, a display for displaying data which are generated by the data processing unit so as to be displayed and a printing unit, particularly a printer, for printing printed data generated by the data processing unit. More specifically, the present invention relates to an electric system which uses a cable-less construction for reducing the cost thereof.

Development of an electric system, for processing domestic information, which handles information processing inside a home, has been vigorously carried out in recent years. This electric system for processing domestic information comprises a data processing unit, an operation apparatus for giving operating information to the data processing unit, a display for displaying displayed data generated by the data processing unit and a printing unit for printing printed data generated by the data processing unit as fundamental constituent elements. However, to put such an electric system into practical use, the system must be easy to operate inside a home.

2. Description of the Related Art

The electric system for processing domestic information according to the prior art employs a construction wherein connection is established by cables between the data processing unit and the operating apparatus, between the data processing unit and the display and between the data processing unit and the printing unit, respectively.

In other words, in the prior art system, the operation apparatus gives operating information to the data processing unit through the cables, and the data processing unit transmits the displayed data to the display through the cables and the printed data to the printing unit through the cables.

The data processing unit such as a personal computer, for example, is equipped with a printer as the printing unit, and this printer executes a processing so as to effect printing. To accomplish this printing processing, the prior art system employs cables to connect the data processing unit and the printer, and transmits the printed data to the printer through the cables.

In the prior art system, however, the system becomes complicated because the cables must be used, and the apparatuses constituting the system cannot be placed far from one another. Another problem is that the possibility of wrong connection of the cables exists.

To solve the problems with the prior art described above, there has been proposed a construction, for example, wherein the data processing unit is equipped with built-in operation apparatus/display/printing unit (e.g., printer). However, such a unitary construction involves a problems in that the individual apparatuses constituting the system cannot be installed in individual rooms and that a television receiver cannot be used as the display. Further, such a system cannot easily satisfy the demand of a user for various printing performance.

Another method of solving the problems with the prior art system to satisfy the user's demand for various levels of printing performance would be one that employs a cable-less construction wherein the data processing unit transmits the printed data to the printer as the printing unit by the use of electromagnetic waves. However, this method does not seem very practical because the data quantity of the printed data becomes enormous. In addition, since a receiving function must be provided to the printer, there occurs the problem that a low cost for production of the printer cannot be accomplished.

### SUMMARY OF THE INVENTION

In view of the problems described above, the main object of the present invention is to provide a novel electric system for processing domestic data capable of solving the problems with the prior art by employing a cable-less construction.

Another object of the present invention is to provide an electric system for processing domestic information equipped with a novel printer, which can solve the problems with the prior art system by accomplishing a cable-less construction of a printer, for printing data generated by the data processing unit, at a reduced cost of production.

To attain these objects, the electric system for processing domestic information according to the present invention employs a construction wherein cables are not used for connection between a data processing unit and an operation apparatus, the operation apparatus is equipped with transmitting means for transmitting operating information to the data processing unit by the use of electromagnetic waves, and the data processing unit is equipped with receiving means for receiving the operation information transmitted from this transmitting means.

Further, the electric system for processing domestic information according to the present invention employs the construction wherein cables are not used for connection between the data processing unit and a display, the data processing unit is equipped with transmitting means for transmitting display data to the display by the use of the electromagnetic waves, and the display is equipped with receiving means for receiving displayed data transmitted from this transmitting means.

Furthermore, the electric system for processing domestic information according to the present invention employs the construction wherein cables are not used for electric connection between the data processing unit and a printing unit, and the data processing unit is equipped with recording means for recording printed data to a recording medium which will be mounted in the printing unit.

Preferably, the printing unit executes processing in such a manner as to read the printed data of the recording medium recorded by the recording means and to print the data.

Preferably, the recording means executes processing in such a manner as to record the printed data in accordance with an image data expansion system.

Further, preferably, the display described above comprises a television receiver.

Further, preferably, the recording medium described above is so constituted as to record the printed data in accordance with the image data expansion system.

In a preferred embodiment of the present invention, the printing unit described above comprises a printer which executes a process in such a manner as to print the printed data generated by the data processing unit. This printer is not equipped with cable connection means for receiving the printed data from outside, but includes data reading means, for reading the recorded data on a recording medium, which is a recording medium mounted in the printer from outside and which records the printed data, and printing control means for managing printing control processing of the printed data read by the data reading means.

In the electric system for processing domestic information according to the present invention, no cable is disposed between the constituent apparatuses of the system but data processing can be executed. Therefore, this system can altogether solve the problems with the prior art system and can use a television receiver, which is available easily and economically, as a display.

In the printer constituted by the present invention, when a recording medium mounting means mounts the recording medium having recorded thereon the printed data generated by the data processing unit, the data reading means reads the printed data recorded on the recording medium. The printing control means controls printing mechanism means and executes the printing process of the printed data thus read.

As described above, the printer according to the present invention can print the printed data generated by the data processing unit without using any cable for exchanging data with outside. Moreover, the printer of this invention need not be equipped afresh with a receiving function, and when the recording medium records the printed data in accordance with an image data expansion system, a character generator need not be provided. Accordingly, the production cost becomes lower than in the prior art.

### BRIEF DESCRIPTION OF THE DRAWINGS

The above object and features of the present invention will be more apparent from the following description of the preferred embodiments with reference to the accompanying drawings, wherein:

FIG. 1 is a schematic block diagram showing an embodiment of an electric system for processing domestic information on the basis of the fundamental principle of the present invention;

FIG. 2 is an overall structural view showing a definite example of the electric system for processing domestic information according to the present invention;

FIG. 3 is a block diagram showing the construction of a data processing unit associated with the definite embodiment of a data processing system constituting the present invention;

FIG. 4 is a hardware structural view showing a printer constituting the definite embodiment of the present invention;

FIG. 5 is a functional block diagram of the printer constituting the definite embodiment of the present invention;

FIG. 6 is a schematic block diagram showing another embodiment of the electric system for processing domestic information when a printing apparatus is a printer;

FIG. 7 is a perspective view showing the appearance of the printer constituting another embodiment of the present invention;

FIG. 8 is a hardware structural view showing the printer shown in FIG. 7;

FIG. 9 is a functional block diagram of the printer shown in FIG. 7;

FIG. 10 is a hardware structural view of a printer according to the prior art; and

FIG. 11 is a functional block diagram showing the printer according to the prior art.

### DESCRIPTION OF THE PREFERRED EMBODIMENTS

Hereinafter, preferred embodiments of the present invention will be described in detail.

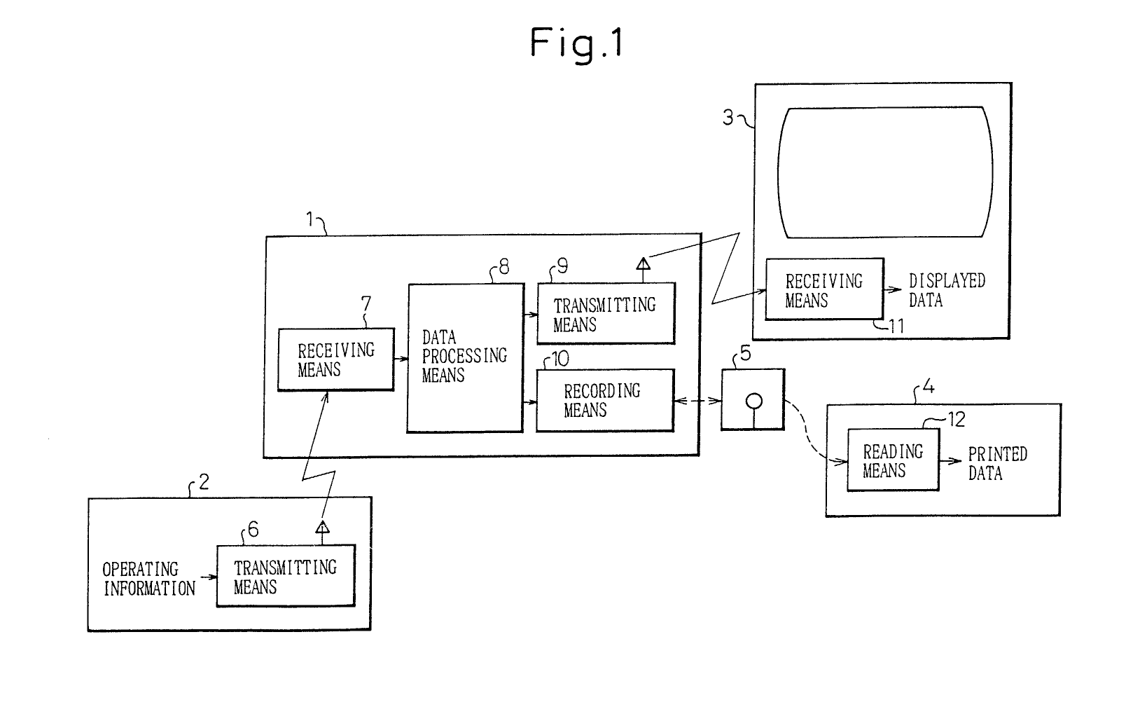

FIG. 1 is a schematic block diagram showing an embodiment of an electric system for processing domestic information which is based on the fundamental principle of the present invention.

In the drawing, reference numeral 1 denotes a data processing unit that constitutes the electric system for processing domestic information according to the present invention, and reference numeral 2 denotes an operation apparatus that similarly constitutes the electric system and sends an operating information to the data processing unit 1. Reference numeral 3 denotes a display, which preferably comprises a television receiver and displays data generated by the data processing unit 1. Reference numeral 4 denotes a printing unit constituting the electric system according to the present invention, which prints data generated by the data processing unit 1.

In the electric system for processing domestic information of the present invention shown in FIG. 1, no cable is disposed between the data processing unit 1 and the operation apparatus 2, between the data processing unit 1 and the display 3 and between the data processing unit 1 and the printing unit 4.

Reference numeral 5 denotes a recording medium which is removably fitted to the printing unit 4 and stores the to-be-printed data generated by the data processing unit 1. An example of the recording medium is a floppy disk or an IC card memory. This recording medium 5 sometimes records the to-be-printed data in accordance with an image data expansion system.

Reference numeral 6 denotes transmitting means provided in the operation apparatus 2; 8 is receiving means provided in the data processing unit 1; 8 is data processing means provided in the data processing unit 1; 9 is transmitting means similarly provided in the data processing unit 1; 10 is recording means similarly provided in the data processing unit 1; 11 is receiving means provided in the display 3; and 12 is reading means provided in the printing unit 4.

The operation apparatus 2 in the present invention transmits operating information to the data processing unit 1 by electromagnetic waves such as light in accordance with processing of the transmitting means 6. On the other hand, the data processing unit 1 receives this operating information in accordance with the processing of the receiving means 7 and delivers the information to the data processing means 8. In this way, data processing is executed.

On the other hand, when the data processing means 8 generates the displayed data, the data processing unit 1 transmits this displayed data to the display 3, using the electromagnetic waves, in accordance with the processing of the transmitting means 9, and the display receives this displayed data in accordance with the processing of the receiving means and displays the data on the screen thereof.

When the data processing means 8 generates printed data, the data processing unit 1 records this printed data on the recording medium loaded thereto, and when this recording medium 5 is mounted in the printed unit 4, the printing unit 4 reads this printed data in accordance with the processing of the reading means 12 and executes a printing process to printing papers.

As described above, no cable is provided between the constituent means in the electric system for processing domestic data shown in FIG. 1 and under such a state, the data processing can still be executed. Accordingly, all the problems with the prior art system can altogether be solved. Further, a television receiver can be employed as the display 3.

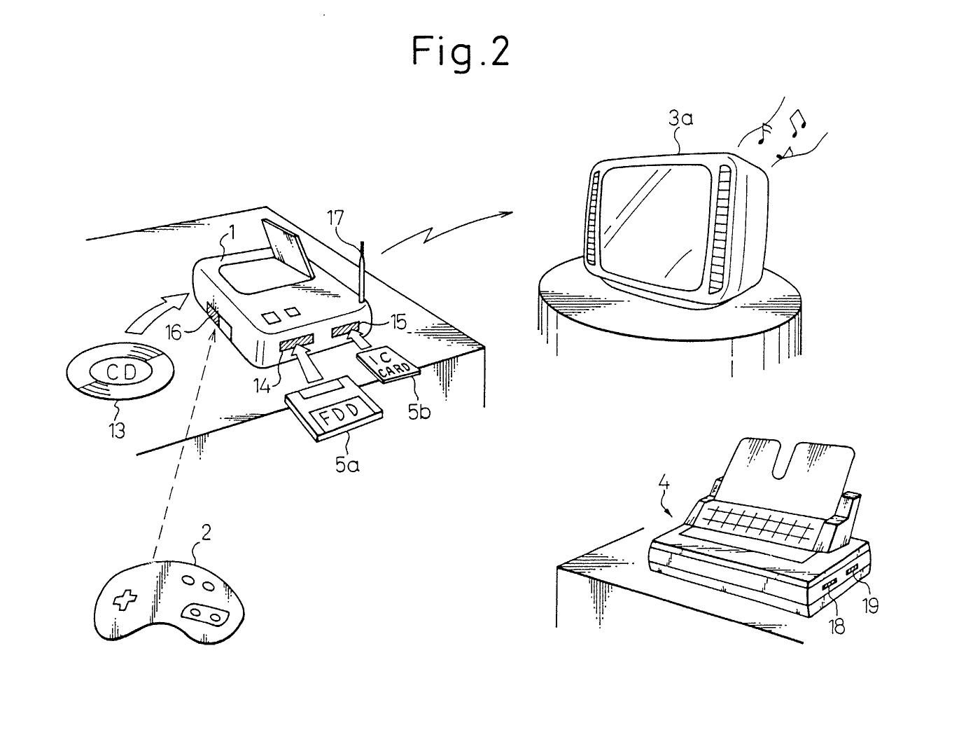

Next, FIG. 2 shows the overall construction of a definite embodiment of the electric system for processing domestic information constituted in accordance with the present invention. In the drawing, like reference numerals will be used to identify like constituents as in FIG. 1.

Reference numeral 3a denotes a television receiver as the display 3; 5a is a floppy disk as the recording medium 5; 5b is an IC memory card as the recording medium 5; and 13 is a CD-ROM to be fitted to the data processing unit 1.

Reference numeral 14 denotes a floppy disk loading port provided to the data processing unit 1 for loading the floppy disk 5a; 15 is an IC memory card loading port provided to the data processing unit 1 for loading the IC memory card 5b; 16 is an infrared(IR)-ray receiving portion provided on the data processing unit 1 for receiving infrared rays transmitted from the operation apparatus 2; and 17 is an antenna provided on the data processing unit 1 for transmitting the displayed data to the television receiver 3a.

Reference numeral 18 denotes a floppy disk loading port provided on the printing unit 4 for loading the floppy disk 5a, and reference numeral 19 denotes an IC memory card loading port provided on the printing unit 4 for loading the IC memory card 5b.

As shown in the drawing, no cable is disposed in the electric system for processing domestic information of this invention between the data processing unit 1 and the operation apparatus 2, between the data processing unit 1 and the television receiver 3a and between the data processing unit 1 and the printing unit 4.

According to the electric system for processing domestic information of the present invention, it is possible to eliminate the problems with the conventional system employing cable connections in that the system becomes complicated, that a long distance cannot be secured between the constituent apparatuses, that wrong connection of the cables is likely to occur, and so forth. Incidentally, when the data processing unit 1 and the printing unit 4 are not of a battery-operated type, power source cables must be provided.

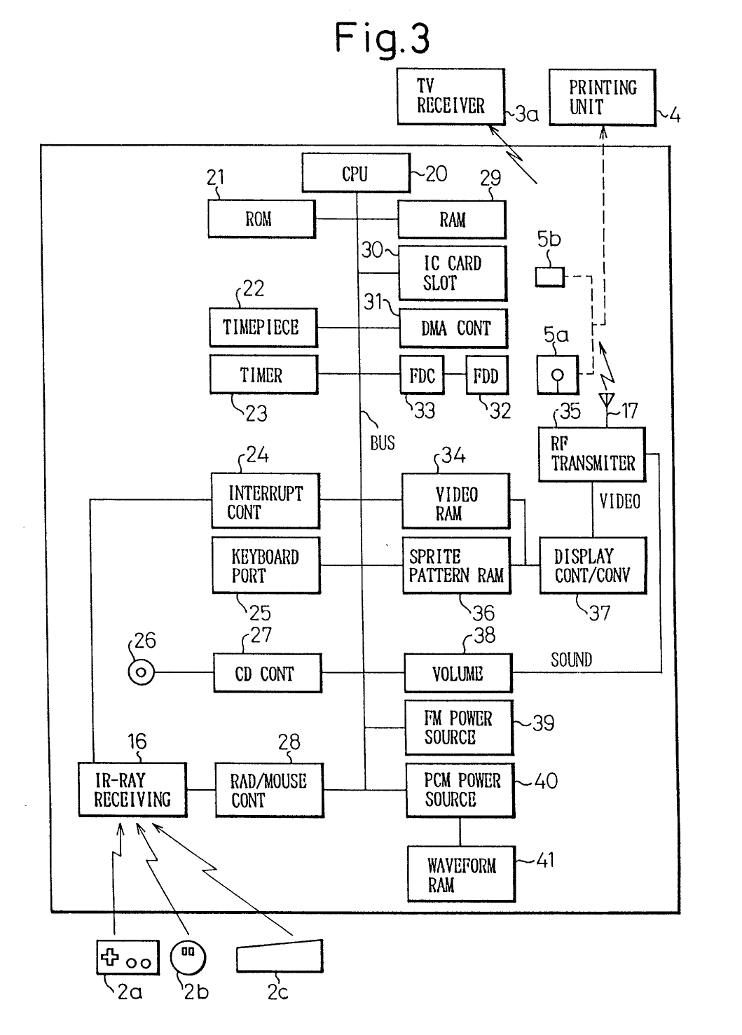

FIG. 3 shows an example of the construction of the data processing unit for accomplishing a definite construction of such a cable-less electric system for processing domestic information.

In this drawing, like reference numerals will be used to identify like constituent apparatuses as in FIGS. 1 and 2. Reference numeral 2a denotes a wireless pad as the operation apparatus; 2b is a wireless mouse as the operation apparatus; and 2c is a wireless keyboard as the operation apparatus 2. The wireless pad 2a, the wireless mouse 2b and the wireless keyboard 2c are disposed outside the data processing unit 1, and supply various operating information to the data processing unit 1.

Reference numeral 20 denotes a CPU; 21 is a ROM; 22 is a built-in timepiece (clock); 23 is a timer; 24 is an interrupt controller; 25 is a keyboard port; 26 is a CD-ROM driver; 27 is a CD controller; 28 is a pad-and-mouse controller; 29 is a RAM; 30 is an IC memory card slot; 31 is a DMA controller; 32 is a floppy disk driver (FDD); 33 is a floppy disk controller (FDC); 34 is a video RAM; 35 is an RF transmitter; 36 is a sprite pattern RAM; 37 is a display control/conversion unit; 38 is an electronic volume control; 39 is an FM power source; 40 is a PCM power source; and 41 is a waveform RAM.

In the data processing unit 1 constituting this system configuration, when the operating information is transmitted, via the infrared-rays, from the wireless pad 2a, the wireless mouse 2b, or the wireless keyboard 2c, the infrared-ray receiving portion 16 receives the operating information, and the keyboard port 25 and the pad-and-mouse controller 28 convert this operating information to data which they can process. The CPU 20 executes the data process in accordance with the commands in this operating information and generates printed data as the printing object and the displayed data as the display object.

When the displayed data is thus generated, the display conversion/control unit 37 generates video signals from the displayed data, and the RF transmitter 35 converts the video signals to television signals and transmits them to the television receiver 3a. Receiving these video signals, the television receiver 3a is operative to display the displayed data generated by the data processing unit 1 on the screen.

As described above, the data processing unit 1 constituting the present invention executes the process thereof in such a manner as to display the displayed data generated by the data process on the television receiver 3a in accordance with the cable-less construction.

When the printed data is generated in the manner described above, the CPU 20 makes access to the IC memory card 5b loaded from the floppy disk loading port 14, through the IC memory card slot 30, and records the printed data to this IC memory card 5b, or makes access to the floppy disk 5a loaded from the IC memory card loading port 15, through the floppy disk driver 32/floppy disk controller 33, and records the printed data to the floppy disk 5a. At this time, the recorded data may be recorded via a code data expansion system or via an image data expansion system. Receiving the floppy disk 5a or the IC memory card 5b having the printed data recorded thereon, the printing unit 4 is operative to print the printed data generated by the data processing unit on printing paper as will be explained next.

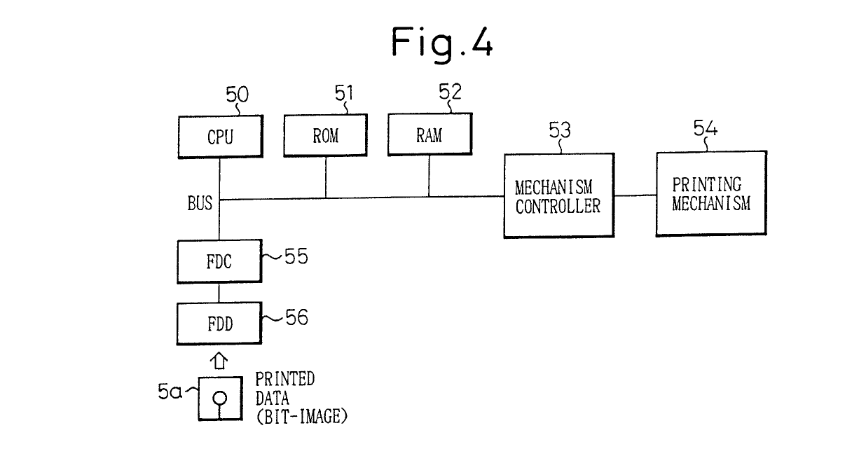

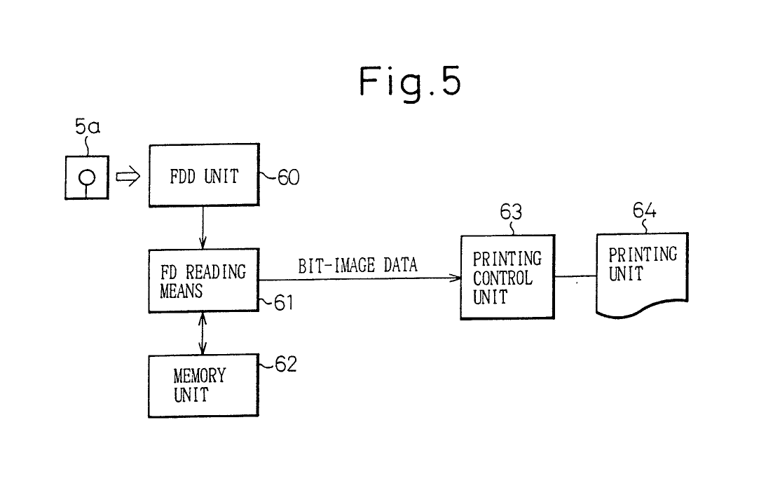

FIG. 4 shows an example of the hardware construction of the printing unit 4 for accomplishing the definite embodiment of the electric system for processing domestic information according to the present invention, and FIG. 5 shows the functional block construction of this printing unit 4. However, the printing unit 4 shown in FIGS. 4 and 5 does not assume installation of the IC memory card 5b for ease of explanation but assumes the case where only the floppy disk 5a can be installed.

In FIG. 4, reference numeral 50 denotes a CPU; 51 is an ROM; 52 is an RAM; 53 is a mechanism controller; 54 is a printing mechanism; 55 is a floppy disk controller; and 56 is a floppy disk driver. In this construction, when the floppy disk 5a records the printed data by the image data (bit-image data) expansion system, a character generator necessary when recording is made by the code data expansion system need not be disposed.

In FIG. 5, reference numeral 60 denotes a floppy disk driver unit; 61 is floppy disk reading means; 62 is a memory unit; 63 is a printing control unit; and 64 is a printing unit.

When the floppy disk 5a having the printed data recorded thereon is loaded into the floppy disk loading port 18 (FIG. 2) in the printing unit 4 constituting the present invention, the floppy disk driver unit 60 drives the thus loaded disk 5a loaded and the floppy disk reading means 61 reads the printed data of the bit-image data expansion system which is recorded on the floppy disk 5a thus driven, while temporarily expanding the data into the memory unit 62. The printing control unit 63 controls the printing unit 64 so that it prints the printed data that are read by the floppy disk reading means 61.

In the way described above, the printing unit 4 constituting the present invention executes the printing process of the printed data generated by the data processing unit 1.

In other words, the data processing unit 1 constituting the present invention executes the processing so that the printed data generated by it is printed by the printing unit 4 in accordance with the cable-less construction.

Next, the explanation will further be given on the case where the printing unit 4 comprises a printer.

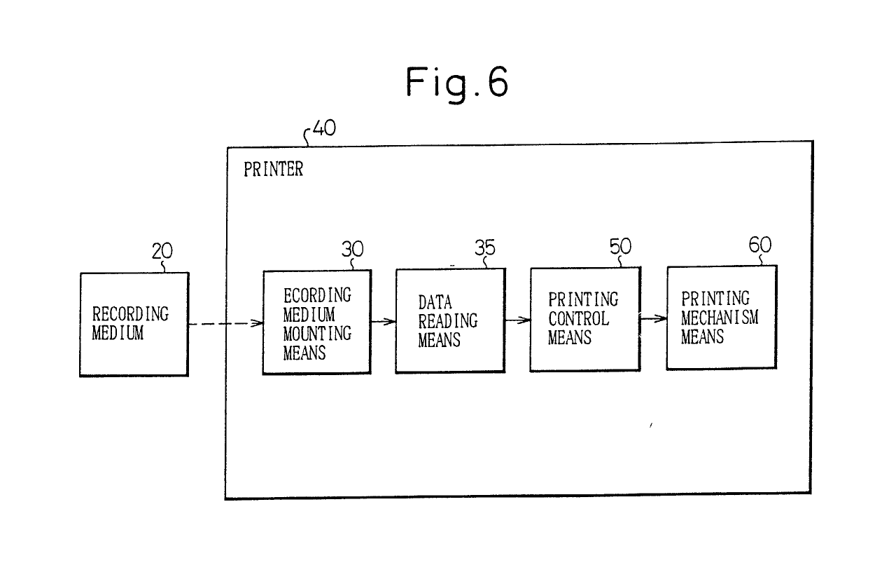

FIG. 6 is a schematic block diagram showing a definite embodiment of the electric system for processing domestic information when the printing unit is a printer.

In the drawing, reference numeral 40 denotes a printer constituted by another embodiment of the present invention. This printer 40 is not equipped with cable connection means for receiving the printed data from outside, as shown in FIG. 6.

Reference numeral 20 denotes a recording medium for recording the printed data generated by the data processing unit, not shown, such as a floppy disk or an IC card memory. This recording medium 20 sometimes records the printed data in accordance with an image data expansion system.

Reference numeral 30 denotes recording medium mounting means provided on the printer 40; 35 is data reading means provided on the printer 40; 50 is printing control means provided on the printer 40; and 60 is printing mechanism means provided on the printer 40.

In the printer 40, having the construction shown in FIG. 6, when the recording medium mounting means 30 mounts the recording medium 20 for recording the printed data generated by the data processing unit, the data reading means 35 reads the printed data recorded on the recording medium 20.

The printing control means 50 controls the printing mechanism means 60 and executes the printing processing of the printed data thus read.

As described above, the printer 40 shown in FIG. 6 is not equipped with cable connection means for data exchange with outside devices but can still print the printed data generated by the data processing unit. Moreover, the printer 40 shown in FIG. 6 need not be equipped afresh with a receiving function. Further, when the recording medium 20 records the printed data in accordance with the image data expansion system, there is no necessity for providing a character generator. Accordingly, this printer 40 is more economical than the printer according to the prior art.

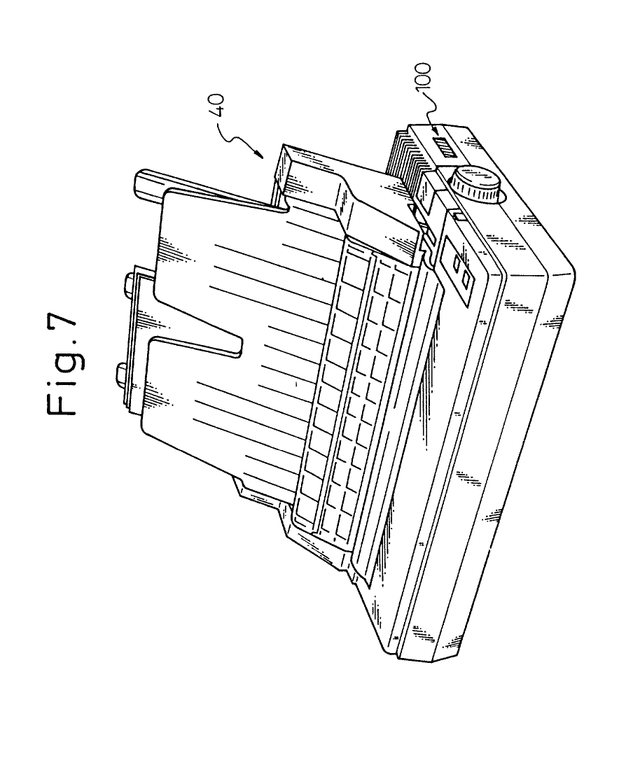

The printer constituting the electric system for processing domestic information shown in FIG. 6 will be explained in further detail with reference to FIGS. 7 to 11.

FIG. 7 shows the appearance of the printer 40 constituted by another definite embodiment of the present invention. In the drawing, reference numeral 100 denotes a floppy disk loading port provided to the printer 40. It serves as a loading port for the floppy disk. The printed data generated by the data processing unit is recorded, preferably in accordance with the image data expansion system, on the floppy disk loaded into the floppy disk loading port 100.

As shown in FIG. 7, the characterizing feature of this printer 40 constituted by the present invention resides in that it does not include any cable connection means for data exchange with outside. However, when a battery is not used as the power source, it can be provided with a power source cable.

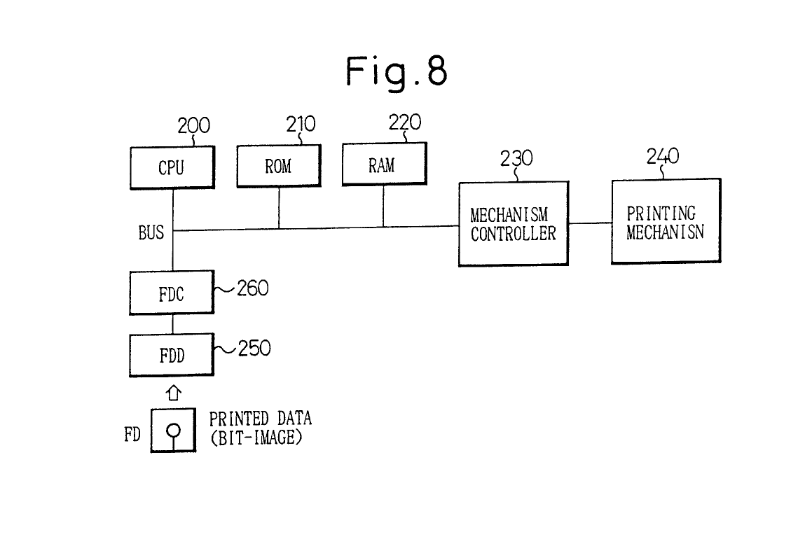

FIG. 8 shows the hardware construction of the printer 40 shown in FIG. 7. In the drawing, reference numeral 200 denotes a CPU; 210 is an ROM; 220 is an RAM; 230 is a mechanism controller; 240 is a printing mechanism; 250 is an FDD for driving a floppy disk loaded from the floppy disk loading port 100; and 260 is an FDC for controlling the FDD 250. When the floppy disk loaded into the floppy disk loading port 100 records the printed data by the image expansion system (the expansion system of bit-images), the printer need not be equipped with a character generator necessary when the recording is made by the code data expansion system.

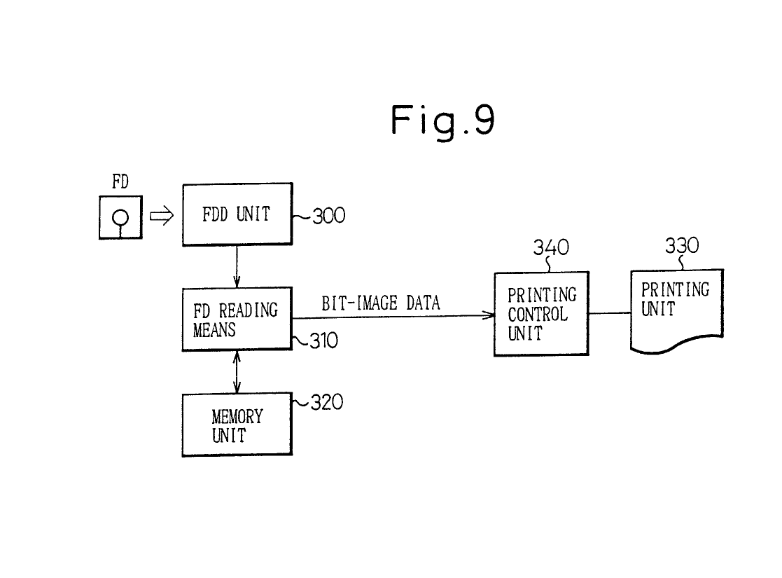

FIG. 9 shows the functional block construction of the printer 40 shown in FIG. 7. As shown in this block diagram, the printer 40 of the present invention is functionally equipped with an FDD unit 300, FD reading means 310, a memory unit 320, a printing unit 330 and a printing control unit 340.

Employing this functional construction, the printer 40 of this invention operates in the following way. When the floppy disk having the printed data recorded thereon is loaded into the floppy disk loading port 100, the FDD unit 300 drives this floppy disk, the FD reading means 310 reads the printed data of the image data expansion system recorded to the floppy disk which is thus driven, while temporarily expanding the data to the memory unit 320, and the printing control unit 340 operates so as to control the printing unit 330 and to print the printed data read by the FD reading means 310.

In this way, the printer 40 of the present invention shown in FIGS. 6 to 9 executes the printing process of the printed data generated by the data processing unit.

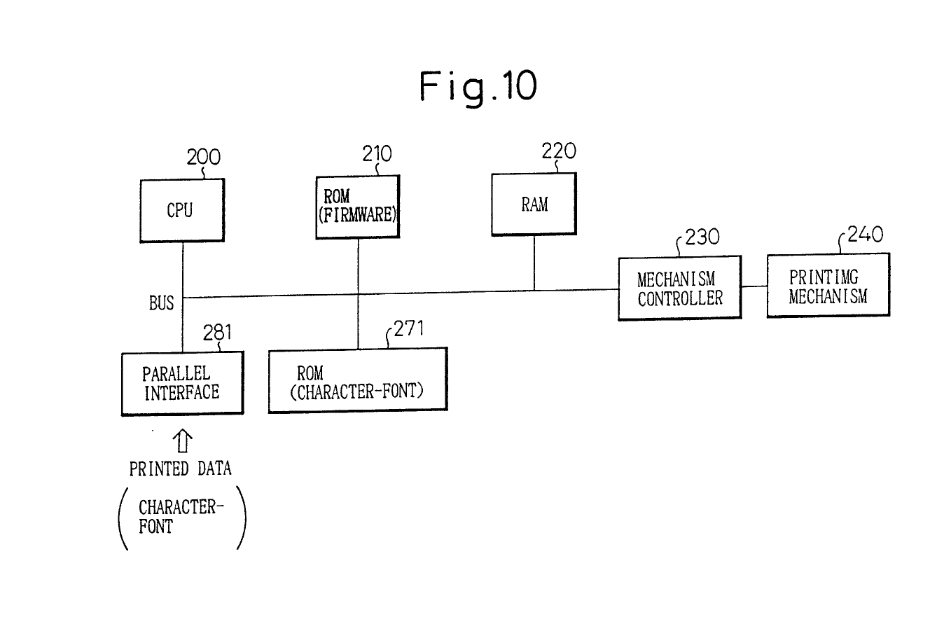

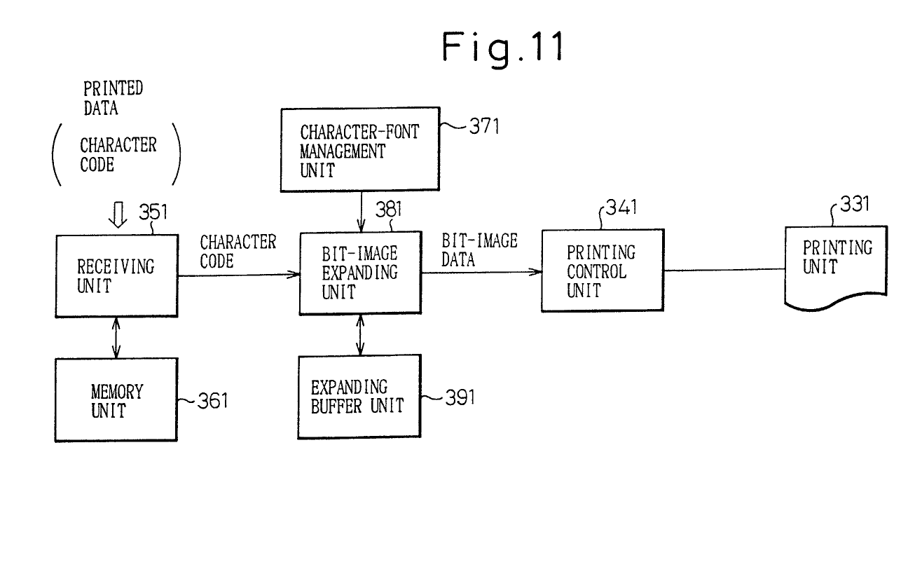

In order to clarify the structural difference between the printer 40 of the present invention and the printer according to the prior art, FIG. 10 shows the hardware construction of the prior art printer and FIG. 11 shows the functional block construction of the prior art printer.

In FIG. 10, like reference numeral is used to identify like constituent element as in FIG. 8. Reference numeral 271 denotes a ROM functioning as a character generator, which is added to the ROM 210 (firmware), and reference numeral 281 denotes a parallel interface for receiving the printed data in the code data expansion system that are transferred from the data processing unit. In this case, the ROM 271 and the parallel interface 281 have to be connected to the printer by means of cables.

In FIG. 11, like reference numerals are used to identify like constituent elements as in FIG. 9. Reference numeral 351 denotes a receiving unit for receiving the printed data from the data processing unit; 361 is a memory unit for temporarily storing the printed data received by the receiving unit; 381 is a character-font management unit for managing the relation of correspondence between the code data and the image data; 381 is a bit-image expanding unit for expanding the printed data received by the receiving unit to the bit images by referring to the character-font management unit 371; and 391 is an expanding buffer unit for temporarily storing the bit image expanded by the bit-image expanding unit 381.

As can be understood from the comparison of FIGS. 8 and 9 with FIGS. 10 and 11, the printer 40 according to the present invention is much simpler in both hardware construction and functional block construction, than the printer according to the prior art.

As explained above, in the electric system for processing domestic data comprising a data processing unit, an operation apparatus for giving the operating information to the data processing unit, the display for displaying the displayed data generated by the data processing unit and the printing unit for printing the printed data generated by the data processing unit, the preferred embodiments of the present invention can accomplish this electric system without using any cables. Therefore, the present invention can altogether solve the problems with the prior art systems, and makes it possible to use the television receiver as the display.

Further, the printer, as a typical example of the printing unit of the present invention, can print the printed data generated by the data processing unit without requiring cable connection means for exchanging data with outside devices. Moreover, the printer described above need not be provided afresh with a receiving function and a character generator. Therefore, the printer can be produced at a lower cost of production than the printers according to the prior art.

While the present invention has been described as related to some preferred embodiments, it will be understood that various changes and modifications may be made without departing from the spirit and the scope of the invention as hereinafter claimed.

1. An electric system for processing domestic information including a data processing unit, an operation apparatus for giving operating information to said data processing unit, a display for displaying displayed data generated by said data processing unit, and a printing unit for printing printed data generated by said data processing unit, wherein
said data processing unit and said operation apparatus employ a construction in which they are not connected by cables, said operation apparatus is equipped with transmitting means for transmitting the operating information to said data processing unit by the use of electromagnetic waves, and said data processing unit is equipped with receiving means for receiving the operating information transmitted from said transmitting means, wherein
said data processing unit and said display employ a construction in which they are not connected by cables, said data processing unit is equipped with transmitting means for transmitting displayed data to said display by the use of electromagnetic waves, and said display is equipped with receiving means for receiving displayed data transmitted from said transmitting means, and wherein
said data processing unit and said printing unit employ a construction in which they are not connected by cables, and said data processing unit is equipped with recording means for recording printed data to a recording medium which will be mounted in said printing unit.

2. An electric system for processing domestic information as set forth in claim 1, wherein said printing unit executes a process in such a manner as to read the printed data on said recording medium recorded by said recording means and to print the data.

3. An electric system for processing domestic information as set forth in claim 1, wherein said recording means executes a processing in such a manner as to record the printed data to said recording medium in accordance with an image data expansion system.

4. An electric system for processing domestic information as set forth in claim 2, wherein said recording means executes a processing in such a manner as to record the printed data to said recording medium in accordance with an image data expansion system.

5. An electric system for processing domestic information as set forth in claim 1, wherein said display is a television receiver.

6. An electric system for processing domestic information as set forth in claim 1, wherein said recording medium is a floppy disk or an IC memory card.

7. An electric system for processing domestic information as set forth in claim 2, wherein said recording medium is a floppy disk or an IC memory card.

8. An electric system for processing domestic information as set forth in claim 3, wherein said recording medium is a floppy disk or an IC memory card.

9. An electric system for processing domestic information as set forth in claim 4, wherein said recording medium is a floppy disk or an IC memory card.

10. An electric system for processing domestic information including a data processing unit, an operation apparatus for sending operating information to said data processing unit, a display for displaying displayed data generated by said data processing unit, and a printing unit for printing printed data generated by said data processing unit, wherein said printing unit comprises a printer executing a process in such a manner as to print the printed data generated by said data processing unit, employs a construction in which it is not equipped with cable connection means for receiving printed data from outside devices, and includes:
data reading means for reading recorded data on a recording medium for recording the printed data, said recording medium being mounted in said printer from outside; and
printing control means for managing a printing control process of the printed data read by said data reading means.

11. An electric system for processing domestic information as set forth in claim 10, wherein said recording medium is so constituted as to record printed data in accordance with an image data expansion system.

12. An electric system for processing domestic information as set forth in claim 10, wherein said recording medium is a floppy disk or an IC memory card.

13. An electric system for processing domestic information as set forth in claim 11, wherein said recording medium is a floppy disk or an IC memory card.
